(19) United States
(12) Patent Application Publication
(10) Pub. No.: US 2010/0139435 A1
(43) Pub. Date: Jun. 10, 2010

(54) FOUR-WHEEL VEHICLE

(75) Inventor: Junpei INAGAKI, Shizuoka (JP)

Correspondence Address: YAMAHA;C/O KEATING & BENNETT, LLP, 1800 Alexander Bell Drive, SUITE 200, Reston, VA, 20191, US

(73) Assignee: YAMAHA MOTOR POWER PRODUCTS KABUSHIKI KAISHA, Kakegawa-shi (JP)

(21) Appl. No.: 12/634,014

(22) Filed: Dec. 9, 2009

(30) Foreign Application Priority Data
Dec. 10, 2008 (JP) 2008-314844

(51) Int. Cl. F16H 59/04

(52) U.S. Cl. 74/473.3

(57) ABSTRACT

A four-wheel vehicle includes a compact operation lever unit and is constructed so as to secure a sufficient space between the seat and the dashboard. In the four-wheel vehicle, a main body of the operation lever unit includes a first pivoting member, a stopper, and a second pivoting member. The first pivoting member is pivotable between a first position at which a first drive switching mechanism is set to a first mode, and a second position at which the first drive switching mechanism is set to a second mode. The first pivoting member is biased toward the second position. The stopper is arranged to restrict pivoting of the first pivoting member beyond the second position. The second pivoting member is pivotable in conjunction with an operation lever and includes a contact portion that causes the first pivoting member to pivot to a side of the first position against a biasing force. Further, when the contact portion is brought into contact with the first pivoting member, the second pivoting member sets a second drive switching mechanism to the first mode, and when the contact portion is at a predetermined position separated from the first pivoting member, the second pivoting member sets the second drive switching mechanism to the second mode.

### CROSS-REFERENCE TO RELATED APPLICATION

The present application claims priority from Japanese patent application JP 2008-314844 filed on Dec. 10, 2008, the entire contents of which is hereby incorporated by reference into the present application.

### BACKGROUND OF THE INVENTION

1. Field of the Invention

The present invention relates to a four-wheel vehicle, and more particularly, to a structure of an operation lever unit of the four-wheel vehicle and an arrangement thereof.

2. Description of the Related Art

Conventionally, there is known a small-sized four-wheel vehicle designed to travel over unpaved terrain such as a farm or a ranch. In order to cope with various kinds of terrain, such a four-wheel vehicle is provided with an operation lever unit that performs switching between a two-wheel drive mode and a four-wheel drive mode, and switching of a differential gear between a lock mode and an unlock mode, that is, switching of drive modes of wheels. In a four-wheel vehicle disclosed in JP 2007-269148 A, there is provided an operation lever unit including an operation lever that can be operated in two different directions, and a main body that is provided on a proximal end side of the operation lever. In this operation lever unit, the operation lever arranged to extend from a dashboard toward a seat on which a driver is seated, and the main body is arranged opposite the seat across from the dashboard.

Incidentally, in the small-sized four-wheel vehicle as described above, it is assumed that a driver or passenger who works on a farm, a ranch, etc., gets in and out of the vehicle repeatedly through entrances on both right and left sides of the vehicle, or moves between a driver seat and a passenger seat, while putting on their work shoes, for example. Accordingly, there is a demand for a sufficient space to be secured between the dashboard and the seat on which the driver or passenger is seated.

However, in the four-wheel vehicle disclosed in JP 2007-269148 A, the size of the operation lever unit is large, and hence there arises a problem in that the dashboard projects rearward and a sufficient space cannot be secured between the seat and the dashboard. That is, the operation lever unit provided in this four-wheel vehicle is provided with the operation lever which can be operated in two different directions and has such a structure that combinations of modes of a plurality of drive switching mechanisms are changed in three stages. In the main body of the operation lever unit, a flange pivoting in one direction is provided. Cables connected to the respective drive switching mechanisms are fixed to the flange. Further, in the main body, there is provided a coupling member that interlocks with the flange and pivots in a direction different from the pivoting direction of the flange. Here, the pivoting direction of the coupling member varies in accordance with pivoting of the flange, and in accordance therewith, the cables coupled to the coupling member through ball joints advance or retract in various directions. As a result, the size of the main body that houses the flange, the coupling member, the ball joint, etc., becomes large.

### SUMMARY OF THE INVENTION

In view of the above-mentioned circumstances, preferred embodiments of the present invention provide a four-wheel vehicle including a compact operation lever unit and a structure that secures a sufficient space between the seat and the dashboard.

According to a preferred embodiment of the present invention, a four-wheel vehicle includes an operation lever unit arranged to switch drive modes of wheels, the operation lever unit including a main body and an operation lever. The main body is arranged opposite to a seat on which a driver is seated across from a dashboard. A proximal end of the operation lever is arranged on the main body, and the operation lever extends through the dashboard. The main body includes a first pivoting member, a stopper, and a second pivoting member. The first pivoting member is pivotable between a first position at which a first drive switching mechanism arranged to switch the drive modes of the wheels is set to a first mode, and a second position at which the first drive switching mechanism is set to a second mode, and the first pivoting member is arranged to receive a biasing force toward the second position is applied. The stopper is arranged to restrict pivoting of the first pivoting member beyond the other position. The second pivoting member pivots in accordance with an operation of the operation lever. Further, the second pivoting member includes a contact portion that is brought into contact with the first pivoting member and causes the first pivoting member to pivot in a direction of the first position against the biasing force. Further, when the contact portion is brought into contact with the first pivoting member, a second drive switching mechanism arranged to switch the drive modes of the wheels is set to a first mode, and when the contact portion is spaced away from the first pivoting member, the second drive switching mechanism is set to a second mode.

According to a preferred embodiment of the present invention, the second pivoting member pivoting in accordance with the operation of the operation lever causes the first pivoting member to pivot, and thus combinations of modes of the first drive switching mechanism and the second drive switching mechanism are changed in three stages. Therefore, the ball joints or other structural elements disclosed in JP 2007-269148 A are not required, and it is possible to reduce the size of the main body of the operation lever unit. As a result, it is possible to secure a sufficient space between the seat and the dashboard.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a side view of a four-wheel vehicle according to a preferred embodiment of the present invention.

FIG. 2 is a perspective view illustrating a structure of a drive transmission system of the four-wheel vehicle.

FIG. 3 is a schematic view of a dashboard of the four-wheel vehicle.

FIG. 4A is a side view illustrating a first state of an operation lever unit provided in the four-wheel vehicle.

FIG. 4B is a side view illustrating a second state of the operation lever unit provided in the four-wheel vehicle.

FIG. 4C is a side view illustrating a third state of the operation lever unit provided in the four-wheel vehicle.

FIG. 5 is a sectional view of the operation lever unit provided in the four-wheel vehicle.

FIG. 6A is a schematic view illustrating a first state of an operation lever unit according to a modification of a preferred embodiment of the present invention.

FIG. 6B is a schematic view illustrating a second state of the operation lever unit according to the modification of a preferred embodiment of the present invention.

FIG. 6C is a schematic view illustrating a third state of the operation lever unit according to the modification of a preferred embodiment of the present invention.

### DETAILED DESCRIPTION OF THE PREFERRED EMBODIMENTS

A four-wheel vehicle according to preferred embodiments of the present invention will be described with reference to the drawings.

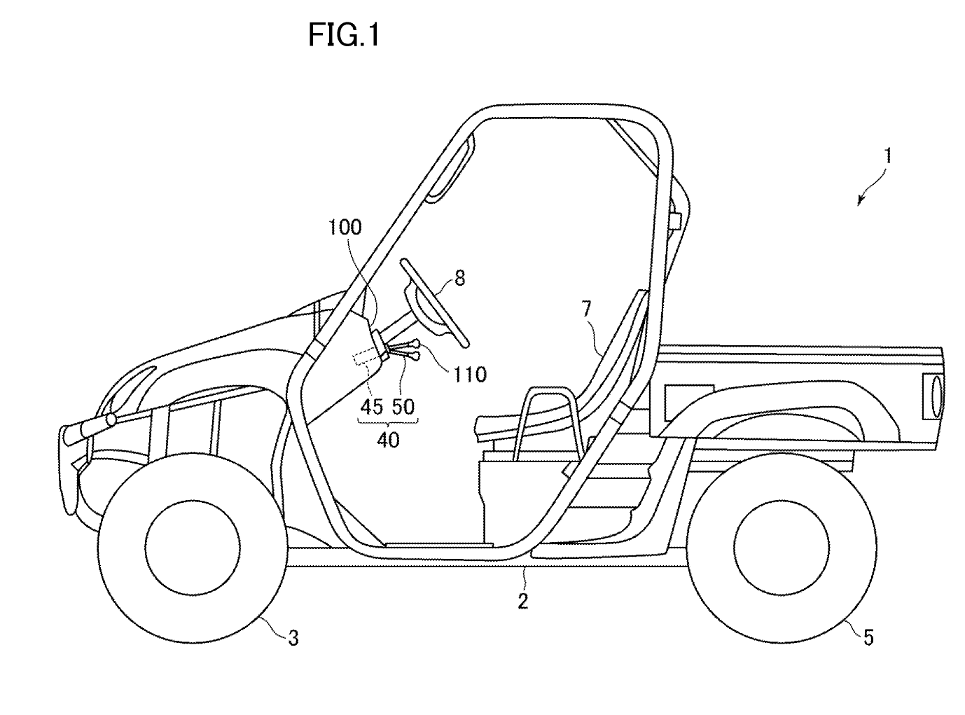

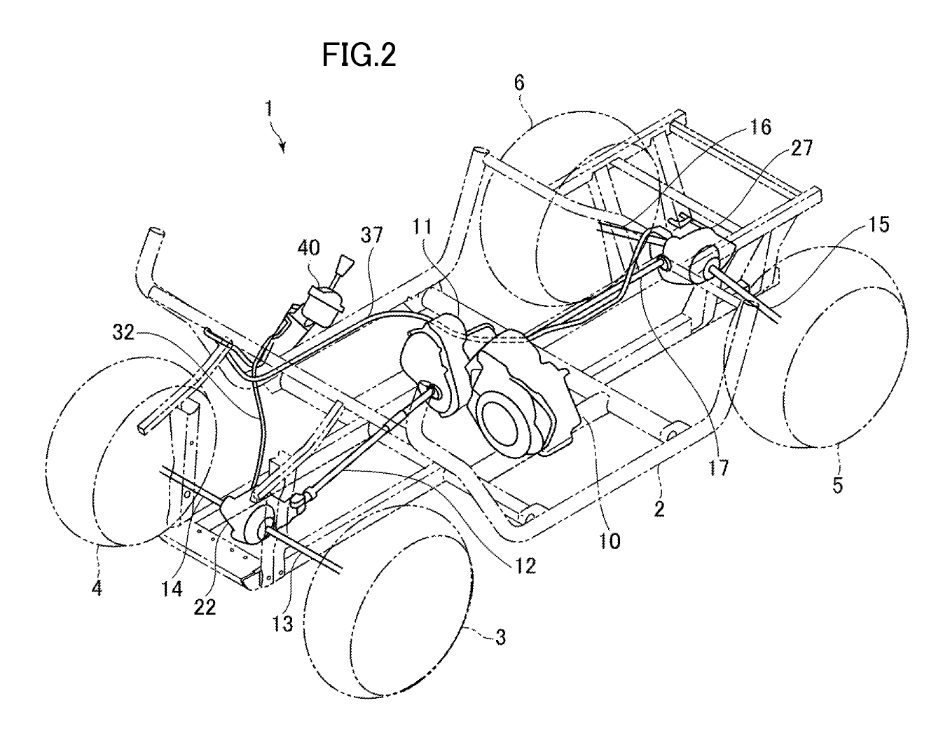

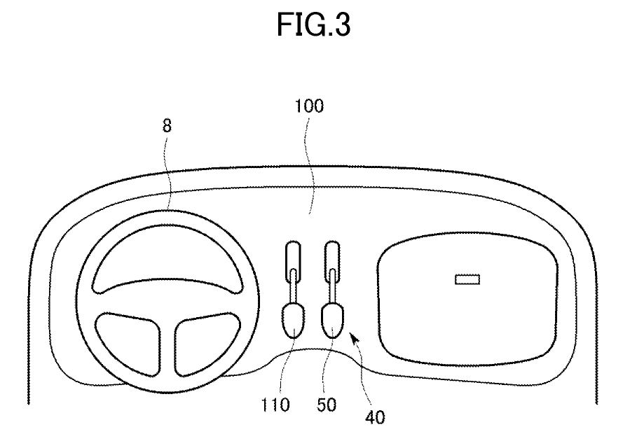

FIG. 1 is a side view of a four-wheel vehicle 1 according to a preferred embodiment of the present invention. FIG. 2 is a perspective view illustrating a structure of a drive transmission system of the four-wheel vehicle 1. The four-wheel vehicle 1 illustrated in FIGS. 1 and 2 preferably is a small-sized off road vehicle, for example. FIG. 3 is a schematic view of a dashboard 100 of the four-wheel vehicle 1. FIG. 3 illustrates the dashboard 100 when viewed from a driver or passenger seated on a seat 7.

As illustrated in FIG. 1, the four-wheel vehicle 1 includes front wheels 3 and 4 arranged on right and left sides of a front portion of a vehicle body frame 2, rear wheels 5 and 6 arranged on right and left sides of a rear portion thereof, the seat 7 arranged at a center portion thereof, and a steering mechanism 8, such as a steering wheel, arranged in front of the seat 7. The seat 7 preferably is a bench seat on which a plurality of people can be seated so as to be aligned in a vehicle width direction. The steering mechanism 8 is provided on the dashboard 100 situated in front of the seat 7. Further, a plurality of operation levers 50 and 110 are provided beside the steering mechanism 8. The operation lever 50 is included in an operation lever unit 40 described below.

As illustrated in FIG. 2, the four-wheel vehicle 1 includes an engine 10 and a transmission 11 at the center portion of the vehicle body frame 2. A drive force of the engine 10 is transmitted from the transmission 11 to a front final reduction gear unit 22 through a front propeller shaft 12, and is further transmitted to the front wheels 3 and 4 through front axles 13 and 14. Similarly, the drive force of the engine 10 is transmitted from the transmission 11 to a rear final reduction gear unit 27 through a rear propeller shaft 17, and is further transmitted to the rear wheels 5 and 6 through rear axles 15 and 16.

The front final reduction gear unit 22 includes a second drive switching mechanism arranged switch the drive modes between a two-wheel drive mode in which rotation of the front propeller shaft 12 is not transmitted to the front axles 13 and 14 and a four-wheel drive mode in which the rotation of the front propeller shaft 12 is transmitted to the front axles 13 and 14. Further, the front final reduction gear unit 22 includes an actuator (not shown) that switches the drive modes. An electric wire 32 extending from the operation lever unit 40 is connected to the actuator.

The rear final reduction gear unit 27 includes a differential gear that changes rotation speed of each of the right and left rear axles 15 and 16 when the four-wheel vehicle 1 turns, and a first drive switching mechanism arranged to switch the drive modes between a lock mode of the differential gear (so-called differential lock mode) and an unlock mode thereof. Further, the rear final reduction gear unit 27 includes a lever (not shown) that switches the drive modes. A wire 37 extending from the operation lever unit 40 is connected to the lever.

As illustrated in FIG. 3, the plurality of operation levers 50 and 110 are provided at the center portion of the dashboard 100 so as to be aligned in the vehicle width direction. The operation lever 110 nearer to the handle 8, that is, provided on the left side can change a gear ratio of the transmission 11. Meanwhile, the operation lever 50 farther from the handle 8, that is, provided on the right side preferably is arranged to switch the drive modes of the above-mentioned two drive switching mechanisms. The operation levers 50 and 110 are arranged so as to be operated preferably in a vertical direction, for example.

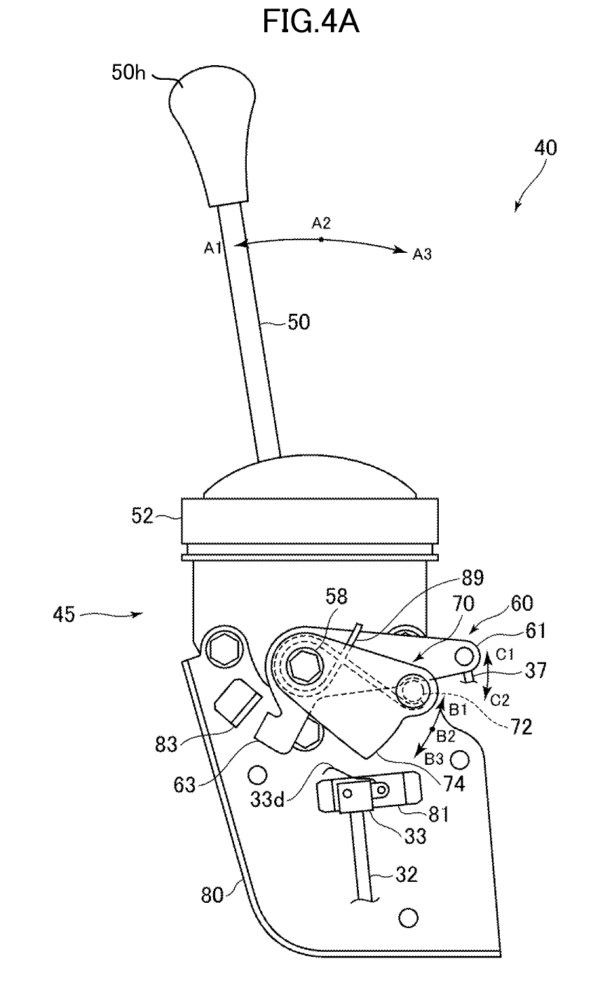

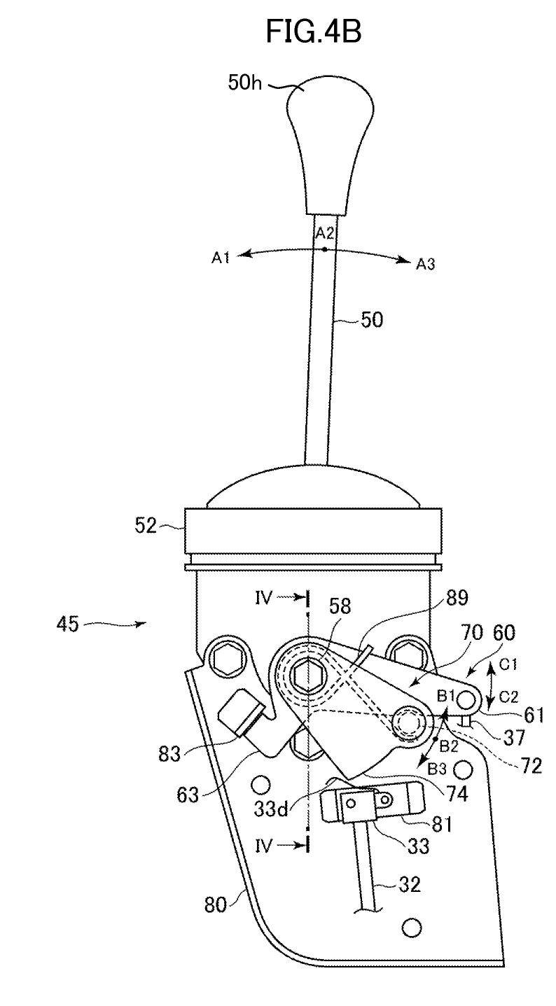

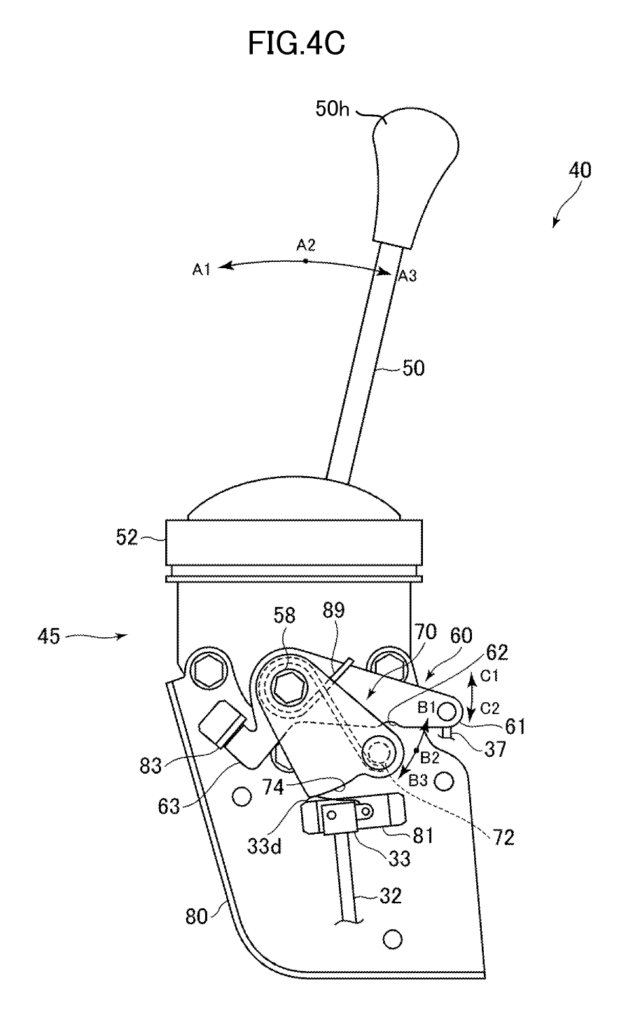

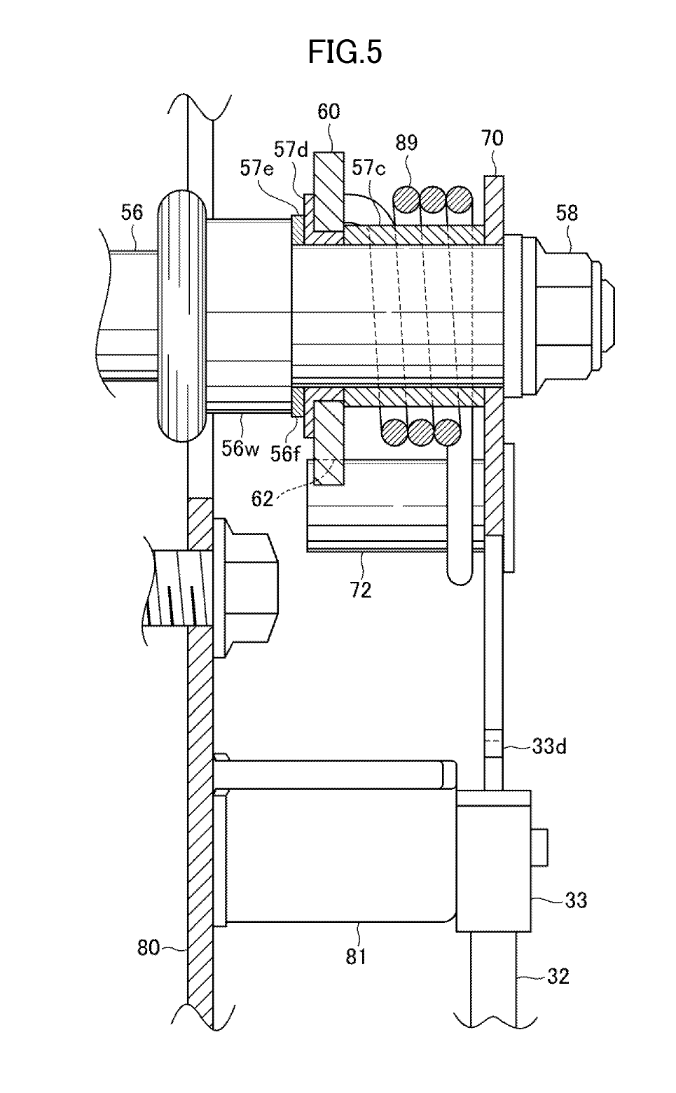

FIGS. 4A to 4C are side views illustrating a first state to a third state of the operation lever unit 40. FIG. 5 is a sectional view of the operation lever unit 40.

The operation lever unit 40 includes the operation lever 50 that is operated by a driver on the four-wheel vehicle 1. The operation lever 50 preferably includes, at a tip end portion thereof, a grip portion 50h that is gripped by a driver. Meanwhile, a proximal end portion of the operation lever 50 is fixed to a pivot shaft (not shown) provided in a case 52. With this structure, the operation lever 50 is pivotable about the pivot shaft in the case 52 along an arrow direction indicated in FIGS. 4A to 4C, and is situated at any one of three positions A1 to A3. Note that as illustrated in FIG. 1, a main body 45 of the operation lever unit 40, which is provided on the proximal end side of the operation lever 50, is retained in front of the dashboard 100. Further, the operation lever 50 is inserted into an opening formed in the dashboard 100, and is arranged to extend rearward of the dashboard 100. In addition to the case 52, the main body 45 includes a first pivoting member 60, a second pivoting member 70, a plate-shaped member 80, and the like which are described below.

Further, as illustrated in FIG. 5, on a side of the case 52, there is provided a shaft portion 56 as a member formed by extending the pivot shaft in the case 52 outwardly. The first pivoting member 60 and the second pivoting member 70 are attached to the shaft portion 56.

The second pivoting member 70 is fixed to the shaft portion 56 preferably with a nut 58, and pivots in accordance with the operation of the operation lever 50. Specifically, the nut 58 fastens the second pivoting member 70 to an end surface 56f of a large diameter portion 56w of the shaft portion 56 together with shaft mounted members 57c to 57e mounted to the shaft portion 56. In contrast, the first pivoting member 60 is pivotably fitted to an outer periphery of the shaft mounted member 57d mounted to the shaft portion 56, and does not interlock with the operation lever 50.

As illustrated in FIGS. 4A to 4C, the second pivoting member 70 is a cam arranged to operate a switch 33 provided at the tip end of the electric wire 32. At the tip end portion of the second pivoting member 70, there is provided a cam surface 74 that is brought into contact with a contact portion 33d of the switch 33. Further, the second pivoting member 70 includes a contact portion 72 extending toward the first pivoting member 60. The switch 33 is fixed to a fixation portion 81 of the plate-shaped member 80 fixed to the case 52. The switch 33 controls the actuator provided in the above-mentioned front final reduction gear unit 22 depending on whether or not the cam surface 74 is in contact with the contact portion 33d. In this manner, the switch 33 switches the drive modes between the two-wheel drive mode and the four-wheel drive mode.

Specifically, the second pivoting member 70 pivots in accordance with the operation of the operation lever 50, and is situated at any one of three positions B1 to B3 in accordance with the three positions A1 to A3 of the operation lever 50, respectively. Here, when the second pivoting member 70 is situated at the first position B1 or the second position B2, the cam surface 74 is out of contact with the contact portion 33d of the switch 33. In this case, the front final reduction gear unit 22 is set to the four-wheel drive mode. In contrast, when the second pivoting member 70 is situated at the third position B3, the cam surface 74 is in contact with the contact portion 33d of the switch 33. In this case, the front final reduction gear unit 22 is set to the two-wheel drive mode. In other words, when the second pivoting member 70 pivots between the second position B2 and the third position B3, switching is performed between the two-wheel drive mode and the four-wheel drive mode.

As illustrated in FIGS. 4A to 4C, the first pivoting member 60 is a lever arranged to operate the wire 37. The first pivoting member 60 includes a coupling portion 61 extending from a pivoting center of the first pivoting member 60 in one direction, and the wire 37 is coupled to the tip end portion of the coupling portion 61. The wire 37 drives a lever provided on the above-mentioned rear final reduction gear unit 27 in accordance with displacement of the coupling portion 61, and thus the differential gear is switched between the lock mode and the unlock mode.

Further, a contact surface 62 that comes into contact with the contact portion 72 of the second pivoting member 70 is provided on one side in a pivoting direction of the coupling portion 61 of the first pivoting member 60. Further, the first pivoting member 60 has a tail end portion 63 extending in a direction different from the extending direction of the coupling portion 61. When the tail end portion 63 is brought into contact with a stopper 83 provided on the plate-like member 80, pivoting of the first pivoting member 60 is restricted.

Further, on the other side of the first pivoting member 60, in the pivoting direction of the coupling portion 61, one end of a spring 89 bridging between the first pivoting member 60 and the second pivoting member 70 is hooked. As illustrated in FIG. 5, the spring 89 is arranged so as to wind around the shaft portion 56. One end of the spring 89 is hooked onto the coupling portion 61 of the first pivoting member 60. The other end of the spring 89 is hooked onto the contact portion 72 of the second pivoting member 70.

Owing to the contact portion 72, the stopper 83, and the spring 89 as described above, the first pivoting member 60 pivots in accordance with a range of pivoting of the second pivoting member 70. Specifically, the first pivoting member 60 pivots in accordance with pivoting of the second pivoting member 70 when the second pivoting member 70 pivots between the first position B1 and the second position B2, and thus pivots between a first position C1 and a second position C2.

When the second pivoting member 70 pivots from the second position B2 to the first position B1, the contact portion 72 pushes up the first pivoting member 60 against a biasing force of the spring 89. In this manner, the first pivoting member 60 pivots from the second position C2 to the first position C1.

When the second pivoting member 70 pivots from the first position B1 to the second position B2, the spring 89 pushes down the first pivoting member 60 by the biasing force. In this manner, the first pivoting member 60 pivots from the first position C1 to the second position C2.

Further, when the first pivoting member 60 reaches the second position C2, the tail end portion 63 is brought into contact with the stopper 83, and hence the first pivoting member 60 is prevented from pivoting beyond the second position C2. Thus, when the second pivoting member 70 pivots from the second position B2 to the third position B3, the contact portion 72 is spaced away from the contact surface 62 of the first pivoting member 60.

Here, when the first pivoting member 60 is situated at the first position C1, the above-mentioned rear final reduction gear unit 27 sets the differential gear to the lock mode. In contrast, when the first pivoting member 60 is situated at the second position C2, the rear final reduction gear unit 27 sets the differential gear to the unlock mode.

As described above, as illustrated in FIG. 4A, when the operation lever 50 is situated at the first position A1, the second pivoting member 70 is situated at the first position B1, and the first pivoting member 60 is situated at the first position C1. In this case, the front final reduction gear unit 22 is set to the four-wheel drive mode, and the differential gear of the rear final reduction gear unit 27 is set to the lock mode.

Further, as illustrated in FIG. 4B, when the operation lever 50 is situated at the second position A2, the second pivoting member 70 is situated at the second position B2, and the first pivoting member 60 is situated at the second position C2. In this case, the front final reduction gear unit 22 is set to the four-wheel drive mode, and the differential gear of the rear final reduction gear unit 27 is set to the unlock mode.

Further, as illustrated in FIG. 4C, when the operation lever 50 is situated at the third position A3, the second pivoting member 70 is situated at the third position B3, and the first pivoting member 60 is held at the second position C2. In this case, the front final reduction gear unit 22 is set to the two-wheel drive mode, and the differential gear of the rear final reduction gear unit 27 is set to the unlock mode.

As described above, according to this preferred embodiment, combinations of the modes of the drive switching mechanisms can be changed in three stages by the operation lever 50 that can pivot in one direction. Thus, it is possible to improve operability of the operation lever 50.

Further, the second pivoting member 70 preferably is a cam arranged to operate the switch 33. Thus, when the operation lever 50 pivots between the second position A2 and the third position A3, and the second pivoting member 70 independently pivots, a relatively light-load operating feeling of the operation lever 50 can be obtained.

Further, the first pivoting member 60 preferably is a lever arranged to operate the wire 37. Thus, when the operation lever 50 pivots between the first position A1 and the second position A2, and the second pivoting member 70 pivots together with the first pivoting member 60, a relatively heavy-load operating feeling of the operation lever 50 can be obtained.

Accordingly, different operating feelings of the operation lever 50 can be obtained between a case where the operation lever 50 pivots between the second position A2 and the third position A3, and a case where the operation lever 50 pivots between the first position A1 and the second position A2. In this manner, utilizing the operating feelings of the operation lever 50, a driver can make sure whether or not an intended operation is performed.

In this preferred embodiment, when the operation lever 50 pivots between the second position A2 and the third position A3 and switching is performed between the two-wheel drive mode and the four-wheel drive mode, the operation lever 50 is operated with a relatively light load. Meanwhile, when the operation lever 50 pivots between the first position A1 and the second position A2 and the differential gear is switched between the lock mode and the unlock mode, the operation lever 50 is operated with a relatively heavy load. This structure is suitable when switching between the two-wheel drive mode and the four-wheel drive mode is performed relatively often.

Note that the present invention is not limited to the above-mentioned preferred embodiment. Switching may be performed between the two-wheel drive mode and the four-wheel drive mode by the first pivoting member 60, and the differential gear may be switched between the lock mode and the unlock mode by the second pivoting member 70. With this structure, the operation lever 50 is operated with a relatively heavy load when switching between the two-wheel drive mode and the four-wheel drive mode is performed, and the operation lever 50 is operated with a relatively light load when the differential gear is switched between the lock mode and the unlock mode. This structure is suitable when switching of the differential gear between the lock mode and the unlock mode is performed relatively often.

Further, in this preferred embodiment, owing to the first pivoting member 60 and the second pivoting member 70 which have a common pivot shaft, the combinations of the modes of the drive switching mechanisms are set in three stages. Thus, in this preferred embodiment, compared to the four-wheel vehicle of JP 2007-269148 A, the size of the main body 45 can be reduced in the extending direction of the operation lever 50 or in the extending direction of the shaft portion 56. As a result, as illustrated in FIG. 1, the dashboard 100 of the four-wheel vehicle 1 is prevented from projecting rearward, and a sufficient space can be secured between the seat 7 and the dashboard 100.

Further, as described above, the size of the main body 45 is reduced. Therefore, as illustrated in FIG. 3, the plurality of operation levers 50 and 110 can be brought close to each other in the vehicle width direction so as to be arranged compactly. In particular, the operation levers 50 and 110 are operated in the vertical direction, and hence the operation levers 50 and 110 can be easily brought close to each other in the vehicle width direction.

Further, as illustrated in FIG. 3, the plurality of operation levers 50 and 110 are situated to the right of the handle 8, and are situated at the upper positions than a position of the operation lever unit disclosed in JP 2007-269148 A. Accordingly, between the seat 7 and the dashboard 100, a particularly low space therebetween can be easily secured.

Though preferred embodiments of the present invention are described above, the present invention is not limited to the above-mentioned preferred embodiment. As a matter of course, various modifications can be made by a person skilled in the art.

In the above-mentioned preferred embodiments, the second pivoting member 70 preferably is a cam arranged to operate the switch 33, and the first pivoting member 60 preferably is a lever arranged to operate the wire 37. However, the present invention is not limited thereto, and the two pivoting members may be levers capable of operating the wire.

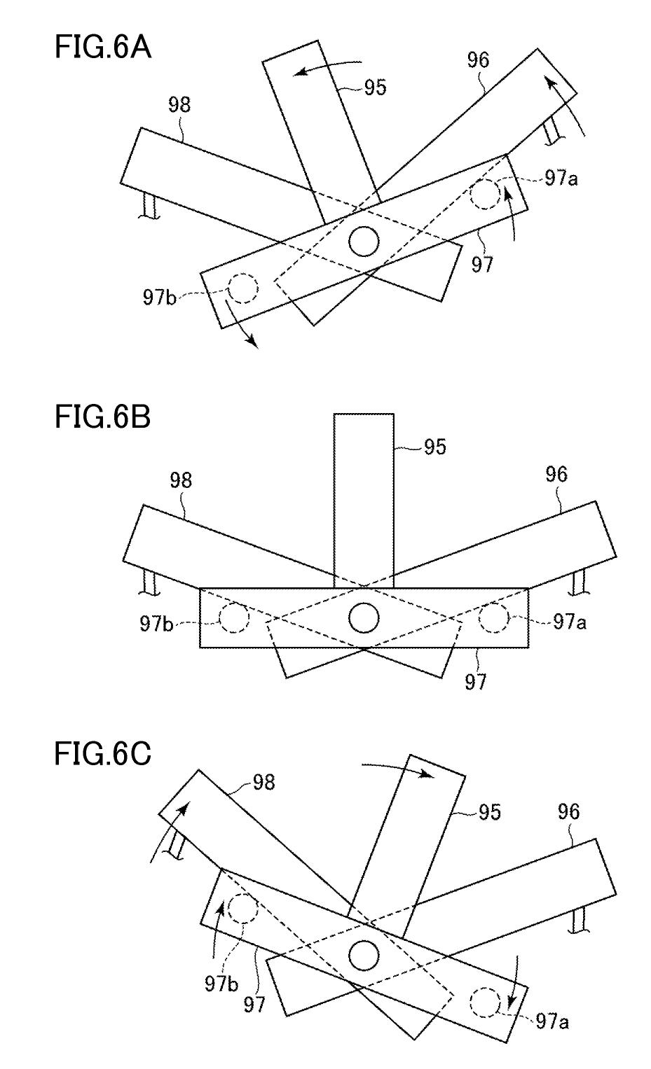

FIGS. 6A to 6C are schematic views illustrating a first state to a third state of an operation lever unit according to a modification of a preferred embodiment of the present invention. In this modification, an operation lever 95, two pivoting members 96 and 98 each connected to a wire, and a drive pivoting member 97 pivoting in accordance with the operation of the operation lever 95 are provided. On the drive pivoting member 97, contact portions 97a and 97b are arranged to cause each of the pivoting members 96 and 98 to pivot. As illustrated in FIGS. 6A to 6C, when the operation lever 95 is operated so as to pivot from its middle position clockwise or counterclockwise in the drawings, only one of the pivoting members 96 and 98 pivots. With this structure, the combinations of the modes of the drive switching mechanisms can be changed in three stages. Note that although a stopper and a spring are preferably included in this modification, similarly to the above-mentioned preferred embodiments, illustration of those members is omitted.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A four-wheel vehicle comprising:
an operation lever unit arranged to switch drive modes of wheels and including:
a main body arranged opposite a seat on which a driver is seated across a dashboard; and
an operation lever including a proximal end arranged on the main body and arranged to extend through the dashboard; wherein
the main body includes:
a first pivoting member arranged to pivot between a first position at which a first drive switching mechanism arranged to switch the drive modes of the wheels is set to a first mode, and a second position at which the first drive switching mechanism is set to a second mode, the first pivoting member being arranged to receive a biasing force toward the second position;
a stopper arranged to prevent pivoting of the first pivoting member beyond the second position; and
a second pivoting member arranged to pivot in accordance with an operation of the operation lever and including a contact portion that is brought into contact with the first pivoting member and causes the first pivoting member to pivot in a direction of the first position against the biasing force; wherein
when the contact portion is brought into contact with the first pivoting member, a second drive switching mechanism arranged to switch the drive modes of the wheels is set to a first mode, and when the contact portion is spaced away from the first pivoting member, the second drive switching mechanism is set to a second mode.

2. The four-wheel vehicle according to claim 1, wherein the second pivoting member includes a cam surface arranged to operate a switch to switch the second drive switching mechanism between the first mode and the second mode.

3. The four-wheel vehicle according to claim 1, wherein the first pivoting member includes a lever that is connected to a wire to switch the first drive switching mechanism between the first mode and the second mode.

4. The four-wheel vehicle according to claim 2, wherein the second drive switching mechanism is arranged to switch between a two-wheel drive mode and a four-wheel drive mode.

5. The four-wheel vehicle according to claim 3, wherein the first drive switching mechanism is arranged to switch between a lock mode and an unlock mode of a differential gear.

6. The four-wheel vehicle according to claim 2, wherein the first drive switching mechanism is arranged to switch between a two-wheel drive mode and a four-wheel drive mode.

7. The four-wheel vehicle according to claim 3, wherein the second drive switching mechanism is arranged to switch between a lock mode and an unlock mode of a differential gear.

8. The four-wheel vehicle according to claim 1, wherein the operation lever is arranged so as to be aligned in a vehicle width direction with a steering mechanism provided on the dashboard.

9. The four-wheel vehicle according to claim 1, wherein the operation lever is arranged so as to be aligned in a vehicle width direction with another operation lever provided in the dashboard.

10. The four-wheel vehicle according to claim 9, wherein the operation lever and the other operation lever are operated in the same direction crossing the vehicle width direction.
